(19) United States
(12) Patent Application Publication
(10) Pub. No.: US 2026/0349758 A1
(43) Pub. Date: Nov. 5, 2026

(54) IMAGE LOADING METHOD AND APPARATUS, AND TERMINAL DEVICE

(71) Applicant: Beijing Zitiao Network Technology Co., Ltd., Beijing (CN)

(72) Inventor: Zechao LI, Beijing (CN)

(21) Appl. No.: 19/486,876

(22) PCT Filed: May 22, 2024
(86) PCT No.: PCT/CN2024/094686

§ 371 Date: Nov. 21, 2025

(30) Foreign Application Priority Data
May 22, 2023 (CN) 202310582822.4

(51) Int. Cl. G06F 9/451; G06F 3/0482; G06F 3/0485; G06F 7/08

(52) U.S. Cl. CPC G06F 9/451; G06F 3/0482; G06F 3/0485; G06F 7/08

(57) ABSTRACT

The present disclosure relates to an image loading method and apparatus and a terminal device. The method comprises: acquiring a network bandwidth for a current round and acquiring the priority of each image in an image list to be loaded; according to the priority of each image, sorting images in said image list to acquire a sorting list; and according to capacity information of each pre-acquired image and the network bandwidth, selecting at least one image from the sorting list as a target image, and loading the target image.

### CROSS-REFERENCE TO RELATED APPLICATIONS

The present disclosure is based on and claims priority to Chinese patent application No. 202310582822.4, filed on May 22, 2023, the disclosure of which is hereby incorporated into the present disclosure by reference in its entirety.

### TECHNICAL FIELD

This disclosure relates to the field of computer technology, particularly to an image loading method and apparatus, and a terminal device.

### BACKGROUND

Service scenarios involving the loading of images in applications are very common. Typically, preloading logic is implemented to ensure users can view images promptly. However, for example, in application scenarios where an image list is configured in applications, and images are displayed based on the image list, some images may normally be preloaded.

### SUMMARY

The present disclosure provides an image loading method and apparatus, and a terminal device to solve some or all of the technical problems in the prior art.

In a first aspect, the present disclosure provides an image loading method, comprising:
obtaining a network bandwidth for a current round, and obtaining a priority of each image in a list of images to be loaded, the priority being determined based on an image loading attribute and a current interactive operation of a user on the list of images to be loaded, and the current round being a round in a cyclic image loading process corresponding to the current time;
sorting images in the list of images to be loaded according to the priority of each image to obtain a sorted list; and
selecting at least one image from the sorted list as target images based on pre-acquired data size information of each image and the network bandwidth, and loading the target image, wherein a priority of each of the target images is higher than a priority of any other image in the list of images to be loaded other than the target images.

In the method provided in an embodiment of the present disclosure, the network bandwidth for the current round and the priority of each image in the list of images to be loaded are obtained. First, the images in the list of images to be loaded are sorted according to the priority of each image. Then, based on the network bandwidth and data size information of each image, images with higher priorities are selected from the sorted list as target images. The selected target images must also satisfy the following constraint condition, namely the priorities of the target images are higher than the priority of any other image in the list of images to be loaded other than the target images.

In a second aspect, the present disclosure provides an image loading apparatus, comprising:
an obtaining module for obtaining a network bandwidth for a current round, and for obtaining a priority of each image in a list of images to be loaded, the priority being determined based on an image loading attribute and a current interactive operation of a user on the list of images to be loaded, and the current round being a round in a cyclic image loading process corresponding to the current time;
a sorting module for sorting images in the list of images to be loaded according to the priority of each image to obtain a sorted list;
a selection module for selecting at least one image from the sorted list as target images based on pre-acquired data size information of each image and the network bandwidth, and loading the target images, wherein a priority of each of the target images is higher than a priority of any other image in the list of images to be loaded other than the target images.

The image loading apparatus provided in an embodiment of the present disclosure obtains a network bandwidth for the current round and a priority of each image in the list of images to be loaded. First, the images in the list of images to be loaded are sorted according to the priority of each image. Then, based on the network bandwidth and data size information of each image, image with higher priorities are selected from the sorted list as target images. The selected target images must also satisfy the following constraint condition, namely the priorities of the target images are higher than the priority of any other image in the list of images to be loaded other than the target images.

In a third aspect, there is provided a terminal device comprising a processor and a memory, wherein:
the memory is configured for storing a computer program;
and the processor is configured for implementing the image loading method as described in any one of the embodiments of the first aspect when executing the program stored in the memory.

In the fourth aspect, there is provided a computer-readable storage medium having stored therein a computer program that, when executed by a terminal device, implements the image loading method according to any one of the embodiments of the first aspect.

### BRIEF DESCRIPTION OF THE DRAWINGS

FIG. 1 is a schematic flowchart of an image loading method provided in an embodiment of the present disclosure;

FIG. 2 is a schematic diagram of a tiled list generated by tiling “historical” target images according to their loading start time provided in the present disclosure;

FIG. 3 is a schematic flowchart of another image loading method provided in an embodiment of the present disclosure;

FIG. 4 is a schematic flowchart of another image loading method provided in an embodiment of the present disclosure;

FIG. 5 is a flowchart of an image loading method provided in the present disclosure;

FIG. 6 is a schematic structure diagram of an image loading apparatus provided in an embodiment of the present disclosure;

FIG. 7 is a schematic structure diagram of a terminal device provided in an embodiment of the present disclosure.

### DETAILED DESCRIPTION

In order to make objectives, technical solutions and advantages of the present disclosure more clear, a clear and complete description are given for the technical solution of the embodiments of this disclosure with reference to the accompanying drawings. Apparently, merely some embodiments of this disclosure, rather than all embodiments thereof, are given herein. All other embodiments obtained by those of ordinary skill in the art based on the embodiments of the present disclosure without creative efforts shall fall within the protection scope of the present disclosure.

It can be understood that before using the technical solutions disclosed in the embodiments of the present disclosure, users should be appropriately informed about the type of personal information involved, the scope of use and application scenarios of the personal information, etc. in accordance with relevant laws and regulations, and authorization should be obtained from the users.

For example, in response to receiving an active request of a user, a prompt message is sent to the user to clearly prompt the user that the requested operation requires the collection and use of the personal information of the user. Thus, the user can independently choose whether to provide personal information to software or hardware, such as the electronic device, applications, servers, or storage media, that performs the operations of the technical solutions of the present disclosure based on the prompted information.

As an optional but non-limiting implementation method, in response to receiving an active request of a user, a prompt message may be sent to the user via a pop-up window in which a text prompt message may be presented. In addition, the pop-up window may also include a selection control for the user to choose whether to “agree” or “disagree” to provide personal information to the electronic device.

It can be understood that the above notification and user authorization process is only illustrative and does not constitute a limitation on the implementation method of this disclosure. Other methods that comply with relevant laws and regulations may also be applied to the implementation method of this disclosure.

It can be understood that the data involved in this technical solution (including but not limited to the data itself, the acquisition or use of data) should comply with the requirements of applicable laws, regulations and relevant rules.

In order to facilitate understanding of the embodiments of the present disclosure, some specific embodiments are further explained below in conjunction with the accompanying drawings. However, these embodiments are not intended to limit the embodiments of the present disclosure.

Current image preloading logic usually has some drawbacks. For example, preloading can affect the loading of images to be displayed at present, or batch loading of a pre-determined number of images can, under certain circumstances, affect loading speed and even lead to wasteful consumption of network resources.

In related technologies, there are some image preloading schemes as follows.
Scheme 1: load images by list view binding-based preloading,
which can be summarized as preloading n2 images from the next list in case where there are n1 list items remaining at the bottom of the list.
Scheme 2: preload based on interface data callback,
which can be summarized as preloading n images in advance in case where a list interface callback occurs.
Scheme 3: preload based on a list scroll position,
which can be summarized as preloading images around the current position in case where a list scrolls to a specific location.

All the three schemes above uniformly preload a predetermined number of images without discrimination. However, preloading a larger number of images would adversely affect the loading of the image at the current position, thereby degrading the user experience. In addition, some schemes may have multiple images in a list to request for loading, but none of the above schemes take into account the different levels of importance of different images to users. Indiscriminate loading may actually adversely affect the loading speed of images that are more important to users.

For example, if a user previews images via a scrollable list when browsing the images, and fast scrolling indicates that many images are not of interest to the user. On the contrary, an image that corresponds to a scrolling pause is the image that the user expects to view. However, the above schemes load images indiscriminately, regardless of whether they are of interest to the user. This not only affects the loading speed of images that are important to the user, but also wastes network resources.

In addition, it is not optimal to load a fixed number of images for different users in different network environments. For example, fast network environments allow more images to be loaded, while slower network environments allow fewer images to be loaded at one time. Loading a fixed number of images indiscriminately also results in a poor user experience due to different network environments.

In view of the above technical problems, embodiments of the present disclosure provide an image loading method and apparatus, and a terminal device.

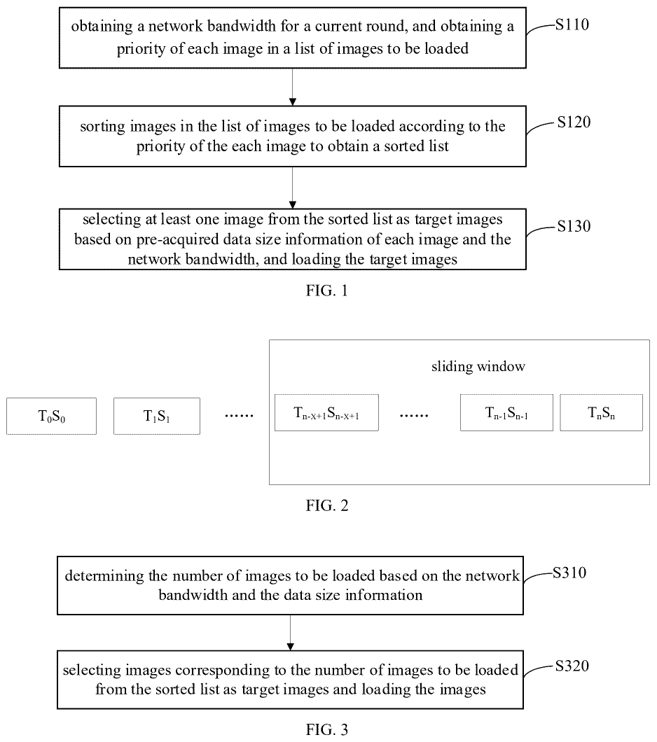

Specific reference can be made to FIG. 1, which is a flowchart of an image loading method provided in an embodiment of the present disclosure. This method comprises the following operations.

At operation S110, a network bandwidth for a current round is obtained, and a priority of each image in a list of images to be loaded is obtained.

In some embodiments, the priority of an image is used to indicate the degree of importance of the image to the user. Here, the priority is determined based on an image loading attribute and the current interactive operation of a user on the list of images to be loaded. The higher the importance, the more the image should be displayed preferentially, so the higher the priority of the image is.

The current round is a round in a cyclic image loading process corresponding to the current time. In some embodiments, the acquisition of the network bandwidth for the current round can be divided into two cases.

In one case where the current round is the first round, it can be determined that no target images are loaded before the current round, and an estimated network bandwidth can be used as the network bandwidth for the current round.

In another case where the current round is not the first round and a preset number of target images have been loaded in a previous round, a total loading time of the preset number of target images can be obtained, and a network bandwidth for the current round is determined based on the total data size information of the preset number of target images and the total loading time.

In some embodiments, the algorithm of “sliding window, moving average” may be employed for estimation. First, the loading start time and total data size information of the target images loaded in the previous round(s) are collected. All collected records are then tiled in a list based on the loading start time. Note that the tiled list includes all “historical” target images loaded from the first round to the previous round, provided there are target image loading records for at least one round prior to the current round. In addition, all ‘historical’ target images are tiled in the list based on the loading start time, and target images to be subsequently loaded will also be further updated in this tiled list. As shown in FIG. 2, a list of a plurality of “historical” target images sorted by loading start time is illustrated. In addition to the loading start time (such as T₀, T₁ . . . Tₙ₋ₓ₊₁ . . . Tₙ₋₁ and Tₙ), the list in FIG. 2 also includes data size information of the images (such as S₀, S₁ . . . Sₙ₋ₓ₊₁ . . . . Sₙ₋₁ and Sₙ). In addition, FIG. 2 also shows a sliding window. The data within the sliding window represents the loading start time and data size information corresponding to the “historical” target images in the previous round.

Then, when determining the network bandwidth for the current round based on the total data size information and total loading time of the target images, calculations can be made based only on the data within the sliding window.

In some embodiments, the network bandwidth for the current round can be calculated according to the following formula:

$$C = \frac{{\sum }_{l = n - x + 1}^{n} {S}_{t}}{T - {T}_{u - x + 1}}$$

where, C represents the network bandwidth for the current round, n−x+1 represents the first target image loaded in the previous round, n represents the last target image loaded in the previous round, T represents the current time, Sᵢ represents the data size information of the iₜₕ image, and T_{n x+1} represents the loading start time of the first target image among the target images loaded in the previous round.

At operation S120, images in the list of images to be loaded are sorted according to the priority of each image to obtain a sorted list.

In some embodiments, the sorting order may be arranged from the highest to the lowest or from the lowest to highest priority, which is not limited herein. The sorted list mentioned here is a priority sorted list.

At operation S130, at least one image is selected from the sorted list as target images based on pre-acquired data size information of each image and the network bandwidth, and the target images are loaded.

In some embodiments, the following constraint condition must be satisfied for selecting an image, i.e., the priority of each of the target images is greater than the priorities of other images in the list of images to be loaded other than the target images.

In other words, the image(s) with the highest priority (or priorities) is selected from the priority-sorted list as the target images, which further confirms the previous presentation that according to the importance of the images, the image(s) with higher importance to the user is/are prioritized for loading.

In addition, considering different network environments, the network bandwidth at current time may vary, and it is necessary to determine an optimal quantity solution for the target images based on the network bandwidth and data size information of each image.

In some embodiments, selecting at least one image from the sorted list as target images based on the pre-acquired data size information of each image and network bandwidth and loading the target images may include:
selecting n images from the sorted list as target images and loading the target images, wherein the total data size of the n images is less than or equal to the network bandwidth, and a sum of the total data size of the n images and the data size of the (n+1)ₜₕ image is greater than the network bandwidth, the (n+1)ₜₕ image being an image with the highest priority in the sorted list other than the n images, and n being a positive integer.

In particular, these n images selected from the sorted list as the target images must not only satisfy the requirement of each having a priority higher than the priority of any image in the list of images to be loaded other than the target images, but also satisfy the requirement that the total data size of the n images is less than or equal to the network bandwidth, and the sum of the total data size of the n images and the data size of the (n+1)ₜₕ image is greater than the network bandwidth, the (n+1)ₜₕ image being the image having the highest priority among the images in the sorted list other than these n images.

The requirement can be specifically referred to by the following expression:

$$\{ \begin{matrix}{\sum }_{t = 0}^{n} {t}_{i} \leq C \\ {\sum }_{t = 0}^{n} f ( {b}_{i} ) \geq {\sum }_{t = 0}^{n} f ( η ) , {b}_{t} ∈ B , η ∈ R\end{matrix} \}$$

where f is a function for solving the importance level of an image, C is the current network bandwidth, tᵢ is the data size information of the iₜₕ image, which can also be understood as the network throughput occupied by the image, A is the list of images to be loaded, vᵢ is the iₜₕ image in the set B, and rᵢ is the iₜₕ image in the set R, B and R constitute the set A, B is the set of target images to be determined in this disclosure, and R is the set of images other than the target images in the list A of images to be loaded.

The reason for setting the total data size of the n images to be less than or equal to the network bandwidth, and the sum of the total data size of the n images and the data size of the (n+1)ₜₕ image to be greater than the network bandwidth, is to ensure that the network bandwidth can be fully utilized without causing network congestion due to the loading of the n images, i.e., to reduce the waste of network resources while maximizing the speed of image loading. In this case, the number of target images obtained is the optimal solution.

In other embodiments, if the data size information of all images is the same, the process of selecting at least one image from the sorted list as the target images based on the pre-acquired data size information of each image and the network bandwidth and loading the target images is further simplified. As shown in FIG. 3, the process comprises the following operations.

At operation S310, the number of images to be loaded is determined based on the network bandwidth and the data size information according to the following formula:

N=C/S
where N is the number of images to be loaded, C is the current network bandwidth, and S is the data size information corresponding to each image.

At operation S320, images corresponding to the number of images to be loaded are selected from the sorted list as target images and are loaded.

It is specified that the priority of each target image is greater than the priority of any image in the list of images to be loaded other than the target images, which is not repeated here. The specific way of selection is also introduced in detail above, and is not repeated here.

For the image loading process, reference can be made to the conventional loading techniques, which is not further explained here.

The image loading method provided in an embodiment of the present disclosure obtains the network bandwidth for the current round and the priority of each image in the list of images to be loaded. First, the images in the list of images to be loaded are sorted according to the priority of each image. Then, based on the network bandwidth and image data size information of each image, images with higher priorities are selected from the sorted list as target images. The selected target images must also satisfy the following constraint condition, namely the priorities of the target images are higher than the priority of any other image in the list of images to be loaded other than the target images. This method can improve the user's experience of accessing an image list, shorten the time required to display important images, and reduce the waste of network traffic.

In some embodiments, before obtaining a network bandwidth for the current round and a priority of each image in the list of images to be loaded, the method further comprises the following processes. Referring to FIG. 4,

At operation S410, image information of each image in the list of images to be loaded is obtained.

At operation S420, the priority of a first image is determined based on a priority impact factor corresponding to the first image.

Wherein, the image information includes priority impact factors and image data size information. The first image is any image in the list of images to be loaded.

In some embodiments, the priority impact factors include one or more of:
a view type corresponding to the first image, a loading trigger mechanism, a distance to an image at the center of a current visible area of a terminal device, and a list scrolling state corresponding to the list of images to be loaded. In some embodiments, each priority impact factor corresponds to a different priority coefficient.

Wherein, the view type corresponds to an image loading priority coefficient. The image loading attribute corresponding to the view type is different from attributes like image types of the loading priority, and the image loading attribute can also be understood as a service attribute explained below.

A priority coefficient V corresponding to the view type can be defined based on a service attribute. For example, the priority coefficient corresponding to avatars is 2, and the priority coefficient corresponding to photos is 1.

The loading trigger mechanism, the distance to an image at the center of the current visible area of a terminal device, and the list scrolling state corresponding to the list of images to be loaded all correspond to the current interactive operation of a user on the list of images to be loaded.

For example, the loading trigger mechanism includes at least one of a view data binding-based trigger mechanism, and a list loading completion-based pre-loading trigger mechanism. Wherein, for example, the priority coefficient S corresponding to the view data binding-based trigger mechanism may be 2, and the priority coefficient S corresponding to the list loading completion-based pre-loading trigger mechanism is 1.

The distance P to an image at the center of the current visible area of a terminal device is determined by the number of images spaced between the first image and the image at the center of the current visible area. It can also be understood as determining the distance P based on the position of images in the list of images to be loaded. Wherein the priority decreases sequentially from the center outward, and a priority coefficient P of the image currently displayed at the center of the screen is 10, which decreases sequentially according to the list pointer. For example, the two images immediately adjacent to the center image on the screen have a priority coefficient P of 9, while the images separated by one image from the center have a priority coefficient P of 8, and so on.

The list scrolling state can include, but is not limited to, the following conditions:
a. if the images remain static or follow the touch (finger tracking), this state is assigned a priority coefficient Z having a maximum value of 10.
b. if the image scrolling speed is less than or equal to a first preset speed threshold v1, this state is defined as browse scrolling and is assigned a priority coefficient Z of 5.
c. if the image scrolling speed is greater than the first preset speed threshold v1, this state is defined as traverse scrolling and is assigned a priority coefficient Z of 1.

Wherein, finger tracking refers to a condition in which an object maintains triggering of the first image for a duration that exceeds a preset time threshold, and during the process of triggering the first image, the scrolling speed is less than a second preset speed threshold v2 which is less than v1.

The priority of each image can be determined based on the priority coefficients corresponding to these four priority impact factors.

The specific formula for calculating the priority is shown as below:

Priority=V×S×P×Z
where Priority represents the priority of the image, and V, S, P, and Z represent the priority coefficients corresponding to the four different priority impact factors introduced above, respectively.

In some embodiments, after each round of target image loading is complete, the method further comprises:
in response to determining that the loading of the target images has been completed, generating callback information to indicate a start of an image loading task in next round.

That is to say, the start of a next loading task is indicated by the callback information, until all the target images that the user expects to load are loaded. Whether the loading is completed can be specifically determined based on a user operation instruction. For example, in response to the user choosing to exit, it is determined that loading is completed. Of course, it is also possible to determine whether loading is completed based on other instructions, which are not limited here.

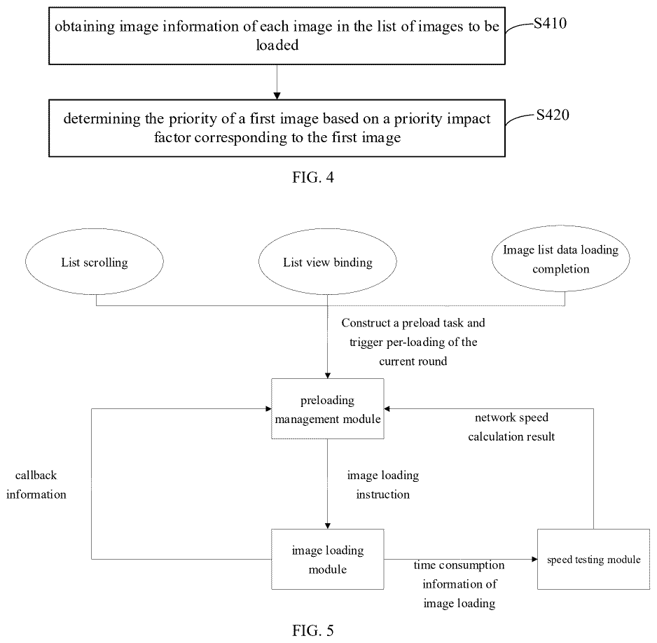

FIG. 5 shows an example of image loading. as depicted in the schematic diagram in FIG. 5. FIG. 5 includes the three image loading scenarios introduced above, such as list scrolling, list view binding, and image list data loading completion. Regardless of which application scenario is involved, a preloading task can be constructed in accordance with the embodiments of this disclosure, and then an image preloading operation can be triggered. Specifically, an image loading instruction can be generated by a preloading management module, and then an image loading module starts loading. In the first round, the number of images to be loaded is determined based on an estimated network bandwidth, and then target images are determined and loaded using the image loading method described above. Time consumption information of loading the target images is collected and input into a testing module. The testing module calculates a current network bandwidth based on the time consumption information of the target images and data size information of the loaded images. Then, the current network bandwidth is input into a preload management module to calculate the number of images to be loaded in the next round. In addition, after image loading is completed, callback information must be generated to indicate the start of an image loading task in the next round.

The specific process is described in detail above, so no further elaboration is given here.

The above is a method embodiment corresponding to the image loading method provided in the present disclosure. Other embodiments corresponding to the image loading method provided in this disclosure are introduced below.

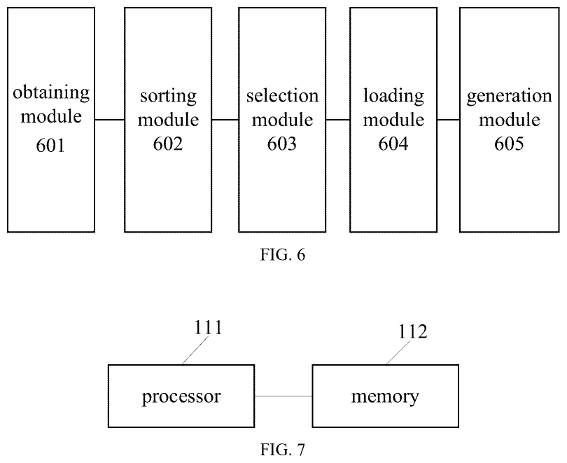

FIG. 6 is a schematic structure diagram of an image loading apparatus provided in an embodiment of the present disclosure. The apparatus comprises: an obtaining module 601, a sorting module 602, a selection module 603, and a loading module 604.

The obtaining module 601 is configured for obtaining a network bandwidth for a current round, and obtaining a priority of each image in a list of images to be loaded, the priority being determined based on an image loading attribute and a current interactive operation of a user on the list of images to be loaded, and the current round being a round in a cyclic image loading process corresponding to the current time.

The sorting module 602 is configured for sorting images in the list of images to be loaded according to the priority of each image to obtain a sorted list.

The selection module 603 is configured for selecting at least one image from the sorted list as target images based on pre-acquired data size information of each image and the network bandwidth, wherein a priority of each of the target images is higher than a priority of any other image in the list of images to be loaded other than the target images.

The loading module 604 is configured for loading the target images.

In some embodiments, the obtaining module 601 is further configured for obtaining image information of each image in the list of images to be loaded, wherein the image information includes priority impact factors and image data size information;
determining a priority of a first image based on a priority impact factor corresponding to the first image, wherein the first image is any image in the list of images to be loaded.

In some embodiments, the priority impact factor include one or more of:
a view type corresponding to the first image, a loading trigger mechanism, a distance to an image at a center of a current visible area of a terminal device, and a list scrolling state corresponding to the list of images to be loaded.

In some embodiments, the view type corresponds to an image loading priority coefficient.

In some embodiments, the loading trigger mechanism includes at least one of:
a view data binding-based trigger mechanism, and a list loading completion-based pre-loading trigger mechanism.

In some embodiments, the distance to the image at the center of the current visible area of the terminal device is determined by a number of images spaced between the first image and the image at the center of the current visible area.

In some embodiments, the list scrolling state corresponding to the list of images to be loaded includes at least one of:
a static state, a finger tracking state, a state in which a scrolling speed is less than or equal to a first preset speed threshold, and a state in which the scrolling speed is greater than the first preset speed threshold, wherein the finger tracking state refers to a condition in which an object maintains triggering of the first image for a duration that exceeds a preset time threshold, and during the process of triggering the first image, the scrolling speed is less than a second preset speed threshold, wherein the second preset speed threshold is less than the first preset speed threshold.

In some embodiments, the priority indicates the degree of importance of an image and the degree of importance of an image is determined based on an image loading attribute and the current interactive operation of a user on the list of images to be loaded.

In some embodiments, the obtaining module 601 is particularly configured for obtaining, in response to no target images loaded before the current round, an estimated network bandwidth as the network bandwidth for the current round; or
obtaining a network bandwidth for the current round, comprising:
in response to a preset number of target images loaded in a previous round before the current round, obtaining a total loading time of the preset number of target images,
determining the network bandwidth for the current round based on total data size information and the total loading time of the preset number of target images.

In some embodiments, the selection module 603 is particularly configured for selecting n images from the sorted list as the target images and loading the target images, wherein total data size of the n images is less than or equal to the network bandwidth, and a sum of the total data size of the n images and a data size of a (n+1)ₜₕ image is greater than the network bandwidth, the (n+1)ₜₕ image being an image with a highest priority in the sorted list other the n images, and n being a positive integer.

In some embodiments, if all the images have the same data size information, the obtaining module 601 is particularly configured for determining a number of images to be loaded based on the network bandwidth and the data size information;
selecting images corresponding to the number of images to be loaded from the sorted list as the target images.

The loading module 604 is particularly configured for loading the target images corresponding to the number of images to be loaded.

In some embodiments, the apparatus further comprises: a generation module 605 for generating callback information to indicate a start of an image loading task in next round in response to determining the loading of the target images has been completed.

The functions performed by the components in the image loading apparatus provided in this disclosure are described in detail in the above embodiment, and are not repeated here.

The image loading apparatus provided in an embodiment of the present disclosure obtains a network bandwidth for the current round and a priority of each image in the list of images to be loaded. First, the images in the list of images to be loaded are sorted according to the priority of each image. Then, based on the network bandwidth and data size information of each image, images with higher priorities are selected from the sorted list as the target images. The selected target images must also satisfy the following constraint condition, namely the priority of each of the target images is higher than the priority of any other image in the list of images to be loaded other than the target images. This method can improve the user's experience of accessing an image list, shorten the time required to display important images, and reduce the waste of network traffic.

It should be noted that, in the above embodiment of the image loading apparatus, the modules included in the image loading apparatus are only divided according to the functional logic, but are not limited to the above division, as long as the corresponding functions can be realized; in addition, the specific names of the functional units are only for the convenience of distinguishing from each other, and are not used to limit the protection scope of the present disclosure. This image loading apparatus can be implemented in software and/or hardware. Specifically, the various modules of the image loading apparatus can be implemented as software components executed on one or more general-purpose processors, or as hardware such as programmable logic devices and/or application specific integrated circuits used to perform certain functions. In some embodiments, the modules included in the image loading apparatus may be embodied in the form of a software product that can be stored in non-volatile storage media. These non-volatile storage media include instructions to cause a computer device (such as a personal computer, a server, a network device, a mobile terminal, etc.) to perform the method described in the embodiments of the present disclosure. In some embodiments, the above modules can also be implemented on a single device or distributed across multiple devices. The functions of these modules can be combined or further divided into multiple sub-modules.

As shown in FIG. 7, an embodiment of the present disclosure provides a terminal device, comprising a processor 111 and a memory 112.

The memory 112 is configured for storing computer programs.

In some embodiments of the present disclosure, the processor 111 is configured for implementing the image loading method provided in any one of the above method embodiments when executing the programs stored in the memory 112. The method comprises:
obtaining a network bandwidth for a current round, and obtaining a priority of each image in a list of images to be loaded, the priority being determined based on an image loading attribute and a current interactive operation of a user on the list of images to be loaded, and the current round being a round in a cyclic image loading process corresponding to the current time;
sorting images in the list of images to be loaded according to the priority of each image to obtain a sorted list;
selecting at least one image from the sorted list as target images based on pre-acquired data size information of each image and the network bandwidth, and loading the target images, wherein a priority of each of the target images is higher than a priority of any other image in the list of images to be loaded other than the target images.

In some embodiments, before the obtaining the network bandwidth for the current round and the priority of each image in the list of images to be loaded, the method further comprises:
obtaining image information of each image in the list of images to be loaded, wherein the image information includes a priority impact factor and image data size information;
determining a priority of a first image based on a priority impact factor corresponding to the first image, wherein the first image is any image in the list of images to be loaded.

In some embodiments, the priority impact factor include one or more of:
a view type corresponding to the first image, a loading trigger mechanism, a distance to an image at a center of a current visible area of a terminal device, and a list scrolling state corresponding to the list of images to be loaded.

In some embodiments, the view type corresponds to an image loading priority coefficient.

In some embodiments, the loading trigger mechanism includes at least one of:
a view data binding-based trigger mechanism, and a list loading completion-based pre-loading trigger mechanism.

In some embodiments, the distance to the image at the center of the current visible area of the terminal device is determined by a number of images spaced between the first image and the image at the center of the current visible area.

In some embodiments, the list scrolling state corresponding to the list of images to be loaded includes at least one of:
a static state, a finger tracking state, a state in which a scrolling speed is less than or equal to a first preset speed threshold, and a state in which the scrolling speed is greater than the first preset speed threshold, wherein the finger tracking state refers to a condition in which an object maintains triggering of the first image for a duration that exceeds a preset time threshold, and during the process of triggering the first image, the scrolling speed is less than a second preset speed threshold, wherein the second preset speed threshold is less than the first preset speed threshold.

In some embodiments, the priority indicates the degree of importance of an image and the degree of importance of an image is determined based on an image loading attribute and the current interactive operation of a user on the list of images to be loaded.

In some embodiments, the obtaining the network bandwidth for a current round comprises:
obtaining, in response to no target images loaded before the current round, an estimated network bandwidth as the network bandwidth for the current round.

In some embodiments, the obtaining the network bandwidth for the current round comprises:
in response to a preset number of target images loaded in a previous round before the current round, obtaining a total loading time of the preset number of target images, and
determining the network bandwidth for the current round based on total data size information and the total loading time of the preset number of target images.

In some embodiments, the selecting the at least one image from the sorted list as the target images based on the data size information of each image and the network bandwidth, and loading the target images comprises:
selecting n images from the sorted list as the target images and loading the target images, wherein total data size of the n images is less than or equal to the network bandwidth, and a sum of the total data size of the n images and a data size of a (n+1)ₜₕ image is greater than the network bandwidth, the (n+1)ₜₕ image being an image with a highest priority in the sorted list other the n images, and n being a positive integer.

In some embodiments, if all the images have the same data size information, the process of selecting the at least one image from the sorted list as the target images based on the data size information of each image and the network bandwidth, and loading the target images comprises:
determining a number of images to be loaded based on the network bandwidth and the data size information;
selecting images corresponding to the number of images to be loaded from the sorted list as the target images and loading the target images.

In some embodiments, the method further comprises:

in response to determining the loading of the target images has been completed, generating callback information to indicate a start of an image loading task in next round.

An embodiment of the present disclosure further provides a computer-readable storage medium stored thereon a computer program that, when executed by a processor, implements the steps of the image loading method provided in the above method embodiment.

An embodiment of the present disclosure further provides a computer program that, when executed by a processor, implements the steps of the image loading method provided in the above method embodiment.

Note that, in this description, the use of relational terms, if any, such as “first” and “second” and the like are used solely to distinguish one from another entity or action without necessarily requiring or implying any actual such relationship or order between such entities or actions. Further, terms “include”, “comprise” or their any other variations are intended to encompass non-exclusive composition, so that a process, method, product or device comprising a series of factors may comprise not only these factors, but also other factors that are not listed explicitly, or factors intrinsic to this process, method, product or device. Without limitation, a factor defined by wording “comprise one . . . ” does not exclude the existence of other same factors in a process, method, product or device comprising such factor.

The above descriptions are only specific embodiments of the present disclosure, so that those skilled in the art can understand or implement the present disclosure. Various modifications to these embodiments will be apparent to those skilled in the art, and the generic principles defined herein may be implemented in other embodiments without departing from the spirit or scope of the present disclosure. Accordingly, the present disclosure should not be limited to the specific embodiments described herein, but should be accorded the broadest scope consistent with the principles and novel features disclosed herein.

1. An image loading method, comprising:
obtaining a network bandwidth for a current round, and obtaining a priority of each image in a list of images to be loaded, the priority being determined based on an image loading attribute and a current interactive operation of a user on the list of images to be loaded, and the current round being a round in a cyclic image loading process corresponding to the current time;
sorting images in the list of images to be loaded according to the priority of each image to obtain a sorted list; and
selecting at least one image from the sorted list as target images based on pre-acquired data size information of each image and the network bandwidth, and loading the target images, wherein a priority of each of the target images is higher than a priority of any other image in the list of images to be loaded other than the target images.

2. The method according to claim 1, wherein before the obtaining the network bandwidth for the current round and the obtaining the priority of each image in the list of images to be loaded, the method further comprises:
obtaining image information of each image in the list of images to be loaded, wherein the image information comprises a priority impact factor and image data size information; and
determining a priority of a first image based on a priority impact factor corresponding to the first image, wherein the first image is any image in the list of images to be loaded.

3. The method according to claim 2, wherein the priority impact factor comprises one or more of:
a view type corresponding to the first image, a loading trigger mechanism, a distance to an image at a center of a current visible area of a terminal device, and a list scrolling state corresponding to the list of images to be loaded.

4. The method according to claim 3, wherein the view type corresponds to an image loading priority coefficient.

5. The method according to claim 3, wherein the loading trigger mechanism comprises at least one of:
a view data binding-based trigger mechanism, and a list loading completion-based pre-loading trigger mechanism.

6. The method according to claim 3, wherein the distance to the image at the center of the current visible area of the terminal device is determined by a number of images spaced between the first image and the image at the center of the current visible area.

7. The method according to claim 3, wherein the list scrolling state corresponding to the list of images to be loaded comprises at least one of:
a static state, a finger tracking state, a state in which a scrolling speed is less than or equal to a first preset speed threshold, and a state in which the scrolling speed is greater than the first preset speed threshold, wherein the finger tracking state refers to a condition in which an object maintains triggering of the first image for a duration that exceeds a preset time threshold, and during the process of triggering the first image, the scrolling speed is less than a second preset speed threshold, wherein the second preset speed threshold is less than the first preset speed threshold.

8. The method according to claim 1, wherein the obtaining the network bandwidth for the current round comprises:
obtaining, in response to no target images loaded before the current round, an estimated network bandwidth as the network bandwidth for the current round.

9. The method according to claim 1, wherein the obtaining the network bandwidth for the current round comprises:
in response to a preset number of target images loaded in a previous round before the current round, obtaining a total loading time of the preset number of target images, and
determining the network bandwidth for the current round based on total data size information and the total loading time of the preset number of target images.

10. The method according to claim 1, wherein the selecting the at least one image from the sorted list as the target images based on the pre-acquired data size information of each image and the network bandwidth, and loading the target images comprises:
selecting n images from the sorted list as the target images and loading the target images, wherein total data size of the n images is less than or equal to the network bandwidth, and a sum of the total data size of the n images and a data size of a (n+1)ₜₕ image is greater than the network bandwidth, the (n+1)ₜₕ image being an image with a highest priority in the sorted list other than the n images, and n being a positive integer.

11. The method according to claim 1, wherein the selecting the at least one image from the sorted list as the target images based on the data size information of each image and the network bandwidth, and loading the target images comprises:
in response to each image having same data size information, determining a number of images to be loaded based on the network bandwidth and the data size information; and
selecting images corresponding to the number of images to be loaded from the sorted list as the target images and loading the target images.

12. The method according to claim 1, further comprising:
in response to determining the loading of the target images has been completed, generating callback information to indicate a start of an image loading task in next round.

13. (canceled)

14. A terminal device comprising a processor and a memory, wherein:
the memory is configured for storing a computer program;
and the processor is configured for implementing an image loading method when executing the program stored in the memory, the image loading method comprising:
obtaining a network bandwidth for a current round, and obtaining a priority of each image in a list of images to be loaded, the priority being determined based on an image loading attribute and a current interactive operation of a user on the list of images to be loaded, and the current round being a round in a cyclic image loading process corresponding to the current time;
sorting images in the list of images to be loaded according to the priority of each image to obtain a sorted list; and
selecting at least one image from the sorted list as target images based on pre-acquired data size information of each image and the network bandwidth, and loading the target images, wherein a priority of each of the target images is higher than a priority of any other image in the list of images to be loaded other than the target images.

15. A non-transitory computer-readable storage medium stored therein a computer program that, when executed by a terminal device, implements an image loading method comprising:
obtaining a network bandwidth for a current round, and obtaining a priority of each image in a list of images to be loaded, the priority being determined based on an image loading attribute and a current interactive operation of a user on the list of images to be loaded, and the current round being a round in a cyclic image loading process corresponding to the current time;
sorting images in the list of images to be loaded according to the priority of each image to obtain a sorted list; and
selecting at least one image from the sorted list as target images based on pre-acquired data size information of each image and the network bandwidth, and loading the target images, wherein a priority of each of the target images is higher than a priority of any other image in the list of images to be loaded other than the target images.

16. The terminal device according to claim 14, wherein before the obtaining the network bandwidth for the current round and the obtaining the priority of each image in the list of images to be loaded, the method further comprises:
obtaining image information of each image in the list of images to be loaded, wherein the image information comprises a priority impact factor and image data size information; and
determining a priority of a first image based on a priority impact factor corresponding to the first image, wherein the first image is any image in the list of images to be loaded.

17. The terminal device according to claim 16, wherein the priority impact factor comprises one or more of:
a view type corresponding to the first image, a loading trigger mechanism, a distance to an image at a center of a current visible area of a terminal device, and a list scrolling state corresponding to the list of images to be loaded.

18. The terminal device according to claim 14, wherein the obtaining the network bandwidth for the current round comprises:
obtaining, in response to no target images loaded before the current round, an estimated network bandwidth as the network bandwidth for the current round.

19. The non-transitory computer-readable storage medium according to claim 15, wherein before the obtaining the network bandwidth for the current round and the obtaining the priority of each image in the list of images to be loaded, the method further comprises:
obtaining image information of each image in the list of images to be loaded, wherein the image information comprises a priority impact factor and image data size information; and
determining a priority of a first image based on a priority impact factor corresponding to the first image, wherein the first image is any image in the list of images to be loaded.

20. The non-transitory computer-readable storage medium according to claim 19, wherein the priority impact factor comprises one or more of:
a view type corresponding to the first image, a loading trigger mechanism, a distance to an image at a center of a current visible area of a terminal device, and a list scrolling state corresponding to the list of images to be loaded.

21. The non-transitory computer-readable storage medium according to claim 15, wherein the obtaining the network bandwidth for the current round comprises:
obtaining, in response to no target images loaded before the current round, an estimated network bandwidth as the network bandwidth for the current round.
